(19) United States
(12) Patent Application Publication
(10) Pub. No.: US 2026/0003939 A1
(43) Pub. Date: Jan. 1, 2026

(54) Trustledger: a modular system for attribution, licensing, and royalty enforcement of ai-generated and human-created content

(71) Applicant: Igli Kocibelli, Melbourne (AU)

(72) Inventor: Igli Kocibelli, Melbourne (AU)

(21) Appl. No.: 19/273,144

(22) Filed: Jul. 18, 2025

(30) Foreign Application Priority Data
Jun. 29, 2025 (AU) 2025204912

(51) Int. Cl. G06F 21/10; G06Q 50/18; H04L 9/32

(52) U.S. Cl. CPC G06F 21/105; G06F 21/1066; G06F 21/1078; G06Q 50/184; H04L 9/3218; H04L 2209/56

(57) ABSTRACT

The invention provides a modular, computer-implemented system and method for managing attribution, licensing, and royalty enforcement of AI-generated digital assets. Known as TrustLedger, the system integrates cryptographic proof mechanisms, programmable royalty routing, and zero-knowledge license validation to enforce intellectual property rights across multi-party generative AI workflows. Core modules include: (1) a Proof-of-Origin engine capturing prompt fingerprints and generation metadata; (2) a Prompt Royalty Engine calculating and distributing royalties based on roles such as prompt engineer, model provider, or dataset curator; (3) a Zero-Knowledge License Enforcer verifying license compliance without disclosing confidential terms; and (4) an Infringement Radar detecting unauthorized use across public content sources. The system supports deployment via SDKs, APIs, or smart contracts, enabling automated enforcement across AI-generated text, code, images, audio, video, and mixed media. TrustLedger facilitates scalable, privacy-preserving IP compliance and empowers creators, developers, and platforms to assert, license, and monetize AI-generated works.

### FIELD

The present invention relates to computer-implemented systems and methods for digital content attribution, licensing, and royalty management, particularly in environments involving generative artificial intelligence (AI). More specifically, the invention provides a modular infrastructure for the secure registration, verification, distribution, and enforcement of intellectual property rights associated with AI-generated content. The system utilizes cryptographic proof mechanisms, programmable smart contracts, and zero-knowledge license validation to support traceability, compliance, and automated rights enforcement across multi-party AI content creation workflows.

### BACKGROUND

The rapid proliferation of AI-generated content has created significant challenges in determining and enforcing intellectual property ownership. In traditional content creation workflows, attribution and licensing are relatively straightforward, with clear authorship, copyright holders, and contractual obligations. However, the use of generative AI models-such as large language models, diffusion-based image generators, and audio synthesis networks--introduces ambiguity regarding ownership, usage rights, and compensation.

Multiple stakeholders, including prompt engineers, model developers, dataset contributors, and platform operators, may each have a legitimate claim to some portion of ownership or revenue. Existing digital rights management (DRM) systems and licensing tools lack the granularity, interoperability, and trust layers needed to support this new landscape. Moreover, companies and creators face the dual challenge of proving authorship while simultaneously respecting license terms of upstream contributors. Many current enforcement mechanisms are either too heavy-handed (e.g., DMCA takedowns) or too weak (e.g., passive watermarking) to resolve disputes effectively or at scale.

There is a pressing need for a system that:
Establishes verified provenance of AI-generated works.
Distributes royalties dynamically based on the actual generative process.
Enables privacy-preserving license validation and enforcement.
Detects and manages infringements proactively without relying on. centralized intermediaries.

### SUMMARY

The present invention, TrustLedger, is a modular computer-implemented system and method for managing attribution, licensing, and royalty enforcement of AI-generated digital assets. It supports a wide range of content types, including text, images, audio, video, source code, and hybrid media.

TrustLedger enables secure, scalable, and privacy-preserving intellectual property (IP) management across generative AI workflows by combining cryptographic proof mechanisms, programmable smart contract logic, and zero-knowledge (ZK) verification techniques (see FIG. 1).

The invention comprises four core interoperable modules:
1. Proof-of-Origin Module 102 Captures metadata related to the content generation process, including prompt content, model identifiers, generation parameters, and cryptographic hashes of both prompt and output. It produces tamper-evident origin certificates that support attribution and prevent fraudulent claims. (see FIG. 2)
2. Prompt Royalty Engine 104 Dynamically calculates and distributes royalties among multiple contributors, such as prompt engineers, model developers, dataset curators, and embedded license holders. The engine adapts royalty logic based on content type, usage context, and license tier. (see FIG. 3)
3. Zero-Knowledge License Enforcer 106 Enables third-party applications and platforms to verify that AI-generated content is properly license—without revealing license details or stakeholder identities. This is achieved through zk-proof validation, ensuring compliance while preserving confidentiality. (see FIG. 4)
4. Infringement Radar 108 and Mirror Vault 110 Monitors public-facing platforms, app stores, and content repositories for unauthorized use of registered AI assets. Upon detection, the system logs evidentiary data—including timestamps, hash matches, and source URLs—into the MirrorVault. It supports retroactive licensing, silent compliance triggers, or enforcement escalation. (see FIG. 5)

These modules form a cohesive and extensible framework for managing rights, attribution, and compliance within generative AI ecosystems.

### BRIEF DESCRIPTION OF DRAWINGS

FIG. 1 illustrates the overall modular architecture of the TrustLedger system 100 and its core components.

FIG. 2 depicts the data flow captured by the Proof-of-Origin Module 102, from prompt input to origin certificate issuance.

FIG. 3 shows the Prompt Royalty Engine 104, including role-based input weighting, contextual license logic, and automated royalty routing.

FIG. 4 illustrates the Zero-Knowledge License Enforcer 106 and its integration with external verification endpoints using zk-proofs.

FIG. 5 displays the Infringement Radar 108 and Mirror Vault 110 scanning public content and storing infringement evidence.

FIG. 6 demonstrates sector-specific overlays for applying TrustLedger logic to domains such as music, software, and legal documentation.

FIG. 7 illustrates the Content-Derived Origin Capture (CDOC) workflow for registering non-prompt-originating assets and protecting creators using non-generative input.

FIG. 8 outlines the legacy creator registration and protection pathway, allowing traditional authors to assert rights and attach provenance to non-AI content.

### DETAILED DESCRIPTION

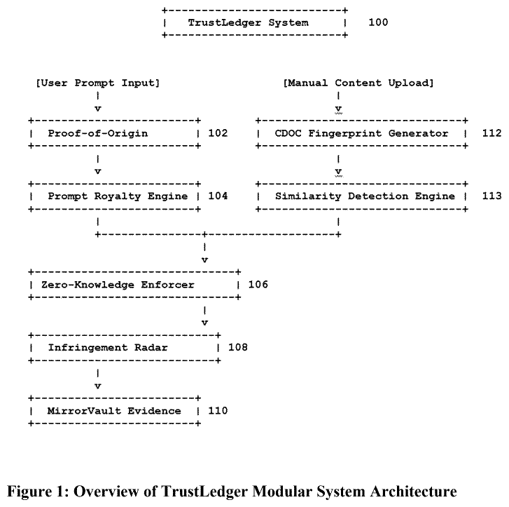

The TrustLedger system 100 comprises four primary interoperable modules, each of which may function independently or as part of an integrated rights management stack. Modules interact via smart contracts, SDKs, and APIs and are designed for seamless deployment within existing AI content generation pipelines, publishing platforms, and digital marketplaces (see FIG. 1).

1. Proof-of-Origin Module 102 The Proof-of-Origin Module 102 captures critical metadata including prompt input, model configuration, generation parameters, and resulting outputs. It generates cryptographic hash signatures and stores timestamped, tamper-evident records. The output of this module includes verifiable origin certificates that can be used to assert authorship, validate licensing, or resolve disputes regarding ownership claims.

2. Prompt Royalty Engine 104 The Prompt Royalty Engine 104 accepts role-weighted inputs from stakeholders such as prompt engineers, dataset providers, model developers, or toolchain contributors. It dynamically routes payments based on use type, volume, and contributor roles, and deploys programmable smart contracts to automate royalty distribution.

2.1 Prompt Uniqueness and Attribution Threshold Not all prompts carry equal creative value. The system distinguishes between trivial and functionally creative prompts using criteria such as contextual richness, functional contribution, and effect on model output. For instance, a generic instruction such as “Create a chill R&B track with African beats” would not typically meet attribution thresholds.

However, when a prompt is part of a larger prompt chain, includes custom model parameters, or is embedded with user-specific metadata, the Proof-of-Origin Module 102 captures this context and generates a unique cryptographic hash incorporating the prompt content, model configuration (e.g., temperature, seed, model ID), and toolchain metadata.

This ensures that:
Generic prompts do not trigger attribution or royalty allocation
Complex, creative, or parameter-rich prompts are properly credited in licensed outputs
Attribution is adjusted dynamically when the prompt is AI-generated rather than human-authored (as described in associated embodiments; see also claim 17)

Unlike systems such as Midjourney or GitHub Copilot, which log prompt-output pairs, TrustLedger integrates provenance hashing, weighted remuneration logic, and verifiable licensing into a modular rights management infrastructure.

3. Zero-Knowledge License Enforcer 106 The Zero-Knowledge License Enforcer 106 enables third-party platforms to confirm whether an asset is properly licensed—without revealing confidential license terms or contributor identities. It employs zero-knowledge proofs (zk-proofs) to validate rights status in a privacy-preserving manner. The module is scalable across both on-chain and off-chain applications, enabling flexible and decentralized license compliance workflows (see FIG. 4).

4. Infringement Radar 108+Mirror Vault 110 The Infringement Radar 108 scans publicly accessible platforms—including NFTs, app stores, content databases, and web archives—for unauthorized reuse of registered AI-generated content. Upon detection, the system logs timestamped evidence into the MirrorVault 110, including cryptographic hash matches, URLs, media snapshots, and source metadata.

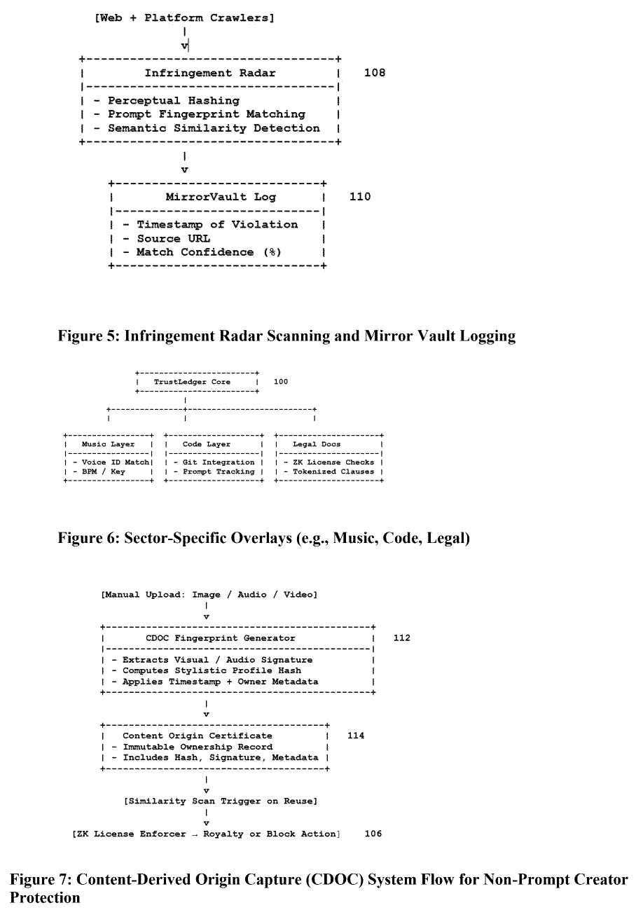

This detection mechanism is directly linked to enforcement pathways, enabling silent license activation, retroactive licensing, or escalation to legal action via smart contract triggers. Unlike traditional watermarking or passive hash-matching systems, this approach provides a closed enforcement loop by coupling detection with verifiable license state checks (see FIG. 5).

Collectively, these modules form a scalable rights infrastructure for digital assets derived from generative AI, supporting attribution, licensing, monetization, and enforcement across text, code, imagery, audio, video, and hybrid media formats.

### PREFERRED EMBODIMENTS

The following embodiments illustrate preferred implementations of the TrustLedger system across various real-world deployment scenarios. These embodiments are provided for illustrative purposes and are not limiting. Each example demonstrates how at least three of the four core modules—Proof-of-Origin 102, Prompt Royalty Engine 104, Zero-Knowledge License Enforcer 106, and Infringement Radar 108 with MirrorVault 110—can be flexibly integrated into domain-specific workflows (see FIG. 1).

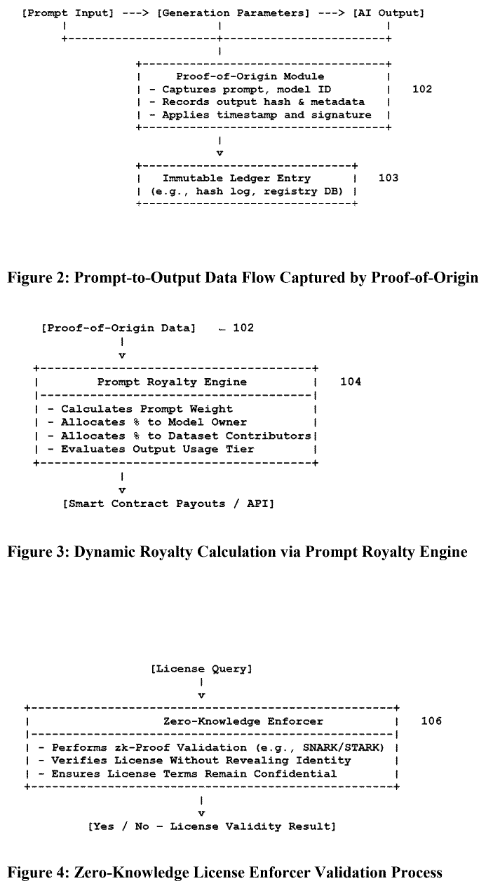

### Embodiment 1: Decentralized Generative Art Marketplace (see FIG. 2, FIG. 3)

Artists submit prompts through a web-based AI interface.
TrustLedger captures the prompt, model ID, and output image via Proof-of-

Origin 102.
Royalties are split: 50% to prompt author, 30% to model owner, 20% to dataset contributors via Prompt Royalty Engine 104.
Buyers receive NFTs containing ZK-licensed proof of usage rights 106.
Infringement Radar 108 monitors NFT marketplaces like OpenSea.

### Embodiment 2: Legal Drafting Automation Platform

Lawyers generate contracts with an AI assistant.
Clause-level prompt and output pairs are recorded using Proof-of-Origin 102.
Licensing obligations from third-party legal datasets are enforced.
ZK License Enforcer 106 integrates with firm intranet for pre-export validation.
Infringement Radar logs unauthorized reuse into MirrorVault 110.

### Embodiment 3: Educational AI Module Distribution (see FIG. 6)

Universities deploy AI-generated quizzes and summaries.
Each module includes embedded Proof-of-Origin 102 and royalty logic for instructors, model creators, and designers 104.
LMS plugins (e.g., Moodle, Canvas) validate student access using the ZK License Enforcer 106.

### Embodiment 4: AI-Based Music Generation Platform (see FIG. 5)

Users describe music via text prompts.
The engine logs inputs and audio outputs via Proof-of-Origin 102.
Royalty Engine 104 allocates per-stream revenue.
Spotify plugin checks ZK license proof before allowing distribution 106.
Infringement Radar 108 monitors YouTube and TikTok.

### Embodiment 5: News Aggregation with AI Summary Engine

Journalists feed links and topics into a summarizer.
Proof-of-Origin 102 logs inputs and summaries.
Prompt Royalty Engine 104 pays original publishers.
ZK enforcement APIs validate news reuse permissions.
MirrorVault 110 tracks usage history.

### Embodiment 6: Copilot-Style Code Generation Platform

Developers generate code with an AI assistant.
Prompt-output pairs are logged 102.
Prompt reuse triggers smart contract royalty events 104.
ZK License Enforcer 106 integrates with CI/CD pipelines.

### Embodiment 7: Avatar and Synthetic Character Generator

Game studios generate NPCs and avatars.
TrustLedger logs designs via Proof-of-Origin 102.
Smart contracts enforce usage rules 106, including in modding ecosystems.

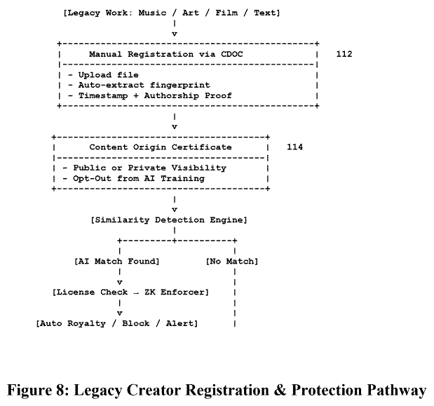

### Embodiment 8: Generative Metaverse & Game Asset Engine (see FIG. 8)

Creators generate in-world skins, environments, and objects.
Prompt Royalty Engine 104 routes value to contributors.
Infringement Radar 108 scans NFT and metaverse marketplaces for clones.

### Embodiment 9: Clinical AI Decision Support Tools

AI systems assist diagnostics from multimodal prompts.
TrustLedger logs patient prompt hashes and outputs 102.
ZK enforcement confirms hospital license tier 106.
Mirror Vault 110 enables medical traceability.

### Embodiment 10: Digital Twin Generators for Infrastructure

Engineers create predictive models using prompt-based generators.
Prompt Royalty Engine 104 tracks reuse across departments.
Government federations use shared licenses 106, enforced via smart contracts.

### Embodiment 11: Advertising and Creative Asset Generators

Agencies generate multimedia ads with AI.
TrustLedger logs creative generation flows 102.
ZK Enforcer 106 confirms digital campaign rights.
Infringement Radar logs unauthorized platform reuse.

### Embodiment 12: Financial Modeling and Risk Analysis AI

Financial institutions generate investment profiles using prompt templates.
Proof-of-Origin 102 creates traceable logs.
Analysts receive royalty share if their prompt logic influences the output 104.

### Embodiment 13: Public-Sector AI for Policy and Civic Tools

Government agencies use AI to translate and draft policies.
TrustLedger enables transparency and modification tracking via Proof-of-Origin 102.
ZK proofs confirm regional access rights 106.

### Embodiment 14: AI-Enhanced Product Listings and Reviews

E-commerce vendors generate bullet points and reviews with AI.
Attribution is preserved and rights are embedded 102, 106.
Competing sellers are blocked from unauthorized reuse.

### Embodiment 15: Academic Reuse with License Constraints (see FIG. 7)

Professors register content via CDOC 112 as “non-commercial only.”
AI repackages the content into microlearning modules.
MirrorVault logs detected reuse.
Royalty Engine 104 compensates original creators.

### Embodiment 16: Government-Sanctioned AI Translation Tools

Governments register base policy text using Proof-of-Origin 102.
NGOs translate with authorized models.
MirrorVault tracks modification chains.
ZK Enforcer 106 ensures only validated actors publish localized versions.

### Embodiment 17: AI Avatar Remix with Legacy Creator Fingerprinting

An artist's estate registers archival characters using CDOC 112.
AI platforms remix avatars with stylistic similarity.
Infringement Radar flags the match.
Estate receives royalty prompts.

### Embodiment 18: Fashion Design Training Data Reuse

A fashion designer uploads full collections into TrustLedger.
Generated garments show visual lineage.
CDOC triggers license check.
Micro-royalties are triggered or reuse is blocked.

### Embodiment 19: Clinical Reporting with Embedded Traceability

Hospitals summarize patient data using AI.
TrustLedger logs hash chains for prompts and outputs 102.
MirrorVault enables liability review.
ZK Enforcer confirms commercial license validity.

### Enablement Example—Music Prompt Chain

Example Prompt: “Generate a chill electronic track with synthwave bass and a lo-fi vibe”
1. Prompt input logged by Proof-of-Origin 102: Prompt hash, model ID, timestamp
2. Prompt Royalty Engine 104:
   40% to prompt author
   30% to model provider.
   30% to dataset curators
3. ZK License Enforcer 106: Generates zk-SNARK proof without revealing identity
4. Spotify plugin checks license proof before enabling uploads
5. Infringement Radar 108 monitors streaming platforms, logs violations in MirrorVault 110

This flow demonstrates automated compliance, modular licensing logic, and real-world enforceability.

### Compliance With USPTO § 101—Technical Implementation

The invention described herein provides a specific, technical solution to a real-world problem: verifying authorship, ownership, and licensing of AI-generated content across decentralized or hybrid digital environments.

The TrustLedger system is not an abstract idea; it is implemented through a layered set of interoperable software modules and cryptographic mechanisms (see FIG. 1), including:
A Proof-of-Origin Module (102) that logs inputs and outputs using content hashes and immutable metadata (see FIG. 2);
A Prompt Royalty Engine (104) that dynamically calculates royalty distributions based on stakeholder weightings and use type (see FIG. 3);
A Zero-Knowledge License Enforcer (106) that employs zk-SNARKs to validate license status without disclosing sensitive license data or identities (see FIG. 4); and
An Infringement Radar (108) that scans content sources for unauthorized use and logs verified violations to the Mirror Vault (110) (see FIG. 5).

These components form a cohesive technical architecture, with functional interoperability and applicability across a wide range of AI-generated content types, including images, audio, code, text, and avatars.

Therefore, the invention constitutes “significantly more” than a conceptual abstraction and is rooted in concrete, machine-implemented technical infrastructure.

### Claim Structure Overview

To assist in examination, this guide provides a structural overview of how the components and claims of the TrustLedger system correspond to described embodiments and fulfill enablement, unity, and clarity requirements. The invention uses a modular architecture (see FIG. 1) with layered claims to support broad applicability while remaining technically specific.

### Claim Layering Structure

### System-Level Claim

Describes the full TrustLedger system (see FIG. 1) integrating four core modules:
Proof-of-Origin (102).
Prompt Royalty Engine (104).
Zero-Knowledge License Enforcer (106).
Infringement Radar+Mirror Vault (108, 110)

Establishes architectural novelty by enabling attribution, licensing, and enforcement of AI-generated content with decentralized or off-chain compatibility.

### Subsystem and Method Claims

Break down the operation and configuration of each module (see FIGS. 2-5):
Proof-of-Origin (102): Captures and cryptographically logs prompts, parameters, and outputs (FIG. 2)
Prompt Royalty Engine (104): Dynamically computes and distributes royalties (FIG. 3)
ZK License Enforcer (106): Verifies usage compliance via zk-proofs (FIG. 4)
Infringement Radar (108): Detects misuse and logs evidence into MirrorVault (110) (FIG. 5)

### Use Case Embodiments

Covers industry-specific implementations (see FIGS. 6-8) including art, law, healthcare, infrastructure, education, and more.

Each use case maps to one or more modules and includes specific monetization or compliance triggers.

Claim-Component Mapping Table

| Claim Tier | Module/Component | Description |
|---|---|---|
| Tier 1 - System | TrustLedger | Modular |
| | Full Stack | architecture |
| | (100) | combining |
| | | 102, 104, 106, 108, 110 |
| Tier 2 - A | Proof-of- | Logs prompts, outputs, |
| | Origin (102) | and metadata for origin |
| | | proofs (see FIG. 2) |
| Tier 2 - B | Prompt Royalty | Distributes royalties |
| | Engine (104) | dynamically (see FIG. 3) |
| Tier 2 - C | ZK License | Verifies license compliance |
| | Enforcer (106) | using zk-proofs (see FIG. 4) |
| Tier 2 - D | Infringement Radar + | Detects and archives |
| | Mirror Vault (108, 110) | violations (see FIG. 5) |
| Tier 3 - | Embodiments 1-14 | Real-world workflows: music, |
| Use Cases | (see FIGS. 6-8) | art, legal, education, etc. |

### Unity of Invention Justification

All claims and embodiments rely on a shared technical core for content attribution, licensing, and enforcement.

Unity is maintained through the consistent use of system modules (102-110) and flow architecture (see FIG. 1) across use cases.

### Enablement and Technical Sufficiency

Each preferred embodiment is feasible with current AI and blockchain technologies, and demonstrates:
Input/output capture via Proof-of-Origin (102)
Royalty logic via Prompt Royalty Engine (104).
zk-based license validation via ZK Enforcer (106).
Evidence collection and audit trails via Infringement Radar and Mirror Vault (108, 110)

All modules are illustrated across FIGS. 1-5 and deployed in vertical-specific scenarios in FIGS. 6-8, showing full enablement without undue experimentation.

### GLOSSARY OF TERMS

### AI-Generated Content

Digital output (e.g., text, image, video, code, audio) created in part or in whole using generative artificial intelligence systems such as LLMs, diffusion models, or neural synthesis engines.

### Proof-of-Origin

A cryptographic module that captures, timestamps, and logs AI input prompts, parameters, and output assets to establish verifiable authorship and traceability.

### Prompt Royalty Engine

A logic-based system that calculates and routes payments or revenue shares among contributors (e.g., prompt engineer, model owner, dataset provider) based on their role and the asset's usage context.

### Zero-Knowledge (ZK) License Enforcer

A privacy-preserving module that verifies whether an AI-generated asset has a valid license-without disclosing the license terms or the identity of the parties involved-using zero-knowledge proof mechanisms.

### Infringement Radar

A content-scanning engine that uses perceptual matching, hashes, or semantic analysis to detect unauthorized usage of registered AI-generated assets across public or private domains.

### Mirror Vault

A tamper-evident log used to archive infringement events detected by the Infringement Radar, including metadata such as URLs, timestamps, similarity scores, and hash proofs.

### Smart Contract

A self-executing program deployed on a blockchain that automates functions like license validation, royalty distribution, and access control based on predefined rules.

### Decentralized Ledger

A distributed database—such as a blockchain—used to store proof-of-origin data, license attestations, or audit trails in an immutable and verifiable manner.

### Prompt Fingerprint

A unique cryptographic hash derived from the input prompt used to generate an AI output, enabling linkage between prompt and asset for provenance and compliance.

### Dynamic Royalty Routing

An adaptive mechanism in which royalties are allocated based on real-world usage, user role, or content performance, rather than fixed or static splits.

### License Compliance Trigger

An event-such as an export, resale, distribution, or public use-that initiates a check via the ZK License Enforcer to validate legal permission.

### Silent Licensing

A post-usage licensing mechanism in which unauthorized use detected by the system can be converted into a valid license agreement without legal escalation.

### Usage Tier

A category (e.g., commercial, educational, nonprofit) that defines licensing terms and royalty rates based on how the content is being used or distributed.

### SDK (Software Development Kit)

A set of tools and libraries allowing third-party developers to integrate TrustLedger modules into their own platforms or services.

### CI/CD Pipeline

Continuous Integration/Continuous Deployment infrastructure used in software engineering where the ZK License Enforcer can validate use of generated code before merging or release.

### NOTES ON APPENDICES

The following appendices are intended to illustrate optional, non-limiting implementations, enforcement extensions, and governance pathways related to the claims herein. Unless explicitly referenced within a claim, no appendix is to be interpreted as essential for enablement or utility of the core system. These modules support broader licensing, enforcement, interoperability, and dispute resolution strategies across evolving regulatory and commercial ecosystems.

These appendices include optional modules and extensions that are not required for enablement of the present claims but may be included in future Continuation-in-Part (CIP) filings. They illustrate potential enforcement, governance, and modular licensing pathways.

### Appendix A—Examiner Navigation Guide

Provides structural guidance for patent examiners, showing how the invention satisfies enablement, clarity, and unity of invention:
Tiered Claim Architecture: System→Subsystem→Use Cases
Component Mapping Table: Claims mapped to modules and embodiments
Unity of Invention Justification: Single inventive concept across all claims
Enablement Support: Preferred embodiments with real-world feasibility
Diagram References: Six visual aids illustrating end-to-end system flow
Supplementary modules in Appendices A-AO further illustrate non-essential but supportive enforcement pathways.

### Appendix B—Claim-Component Mapping Table

This table organizes the claims by functional components using an internal “Tier” structure to aid examiner clarity. These tiers are not labeled in the Claims section but are used here solely to map claims to corresponding technical modules and use cases.

| | |
|---|---|
| TIER 1 → | The whole TrustLedger system |
| \|_ TIER 2A → | Proof-of-Origin module |
| \|_ TIER 2B → | Prompt Royalty Engine |
| \|_ TIER 2C → | ZK License Enforcer |
| \|_ TIER 2D → | Infringement Radar + Mirror Vault |
| \|_ TIER 3 → | Embodiments like music platforms, |
| | law, metaverse use cases |

| Tier | Component/Claim | Description |
|---|---|---|
| Tier 1 | TrustLedger System | Full modular system integrating |
| | Architecture | all four core components |
| Tier 2A | Proof-of- | Logs prompts, generation |
| | Origin | metadata, and outputs to |
| | | establish content provenance |
| Tier 2B | Prompt Royalty | Dynamically calculates and |
| | Engine | routes royalties based on |
| | | stakeholder roles |
| Tier 2C | Zero-Knowledge | Validates license |
| | License | compliance without exposing |
| | Enforcer | confidential license contents |
| Tier 2D | Infringement Radar + | Detects unauthorized use |
| | Mirror Vault | and archives evidence for |
| | | enforcement or licensing |
| Tier 3 | Use Case | Domain-specific |
| (1-14) | Embodiments | implementations mapped to multiple |
| | | industries and scenarios |

### Appendix C—Commercial Use Cases

Image Platforms: Midjourney, Adobe Firefly
Code Assistants: GitHub Copilot, Replit AI
Music: Amper Music, Soundful
Journalism: AI-generated summaries in newsrooms
Education: LMS plugins for AI-driven lesson generation
Gaming & Metaverse: Asset licensing and avatar reuse
Healthcare: Diagnostic decision support
Legal: AI-generated contracts with clause-level tracing
Infrastructure: AI digital twins for city planning
Marketing: Ad generator compliance and brand safety
Finance: Model attribution for investment research
E-commerce: Product description reuse licensing

### Use Case: Watch-Based Royalty Routing With Advertiser Integration

A video platform monetizes user attention through ad revenue. When a user has opted in via TrustHub to share engagement data, TrustLedger receives ZK-verified engagement triggers (e.g., full views, ad skips, likes) and calculates dynamic royalty distributions to all contributors (e.g., creators, editors, AI models). Smart contracts execute micro-payouts based on engagement-weighted formulas, ensuring transparent, fair revenue splits without compromising user privacy or requiring centralized tracking infrastructure.

### Appendix D—Competitive Advantage Summary

First patent unifying ZK licensing, real-time enforcement, and dynamic royalty routing
Works with or without blockchain, enabling maximum adoption
Modular licensing model (API, SaaS, on-chain) for rapid platform integration
Infringement Radar+MirrorVault allows post-violation monetization (silent licensing or litigation)

### Appendix E—Technical Innovations

### 1. Dynamic Multi-Stakeholder Royalty Logic

Smart contracts with real-world use triggers and weighted attribution

### 2. Privacy-Preserving License Verification

ZK-proof-based compliance checks without exposing terms

### 3. Modular Enforcement Infrastructure

SDK/Smart Contract/Cloud compatible, works across verticals

### 4. Infringement Radar

Live scanning, perceptual hashing, MirrorVault incident logs

### 1. Ad-Engagement-Based Smart Contract Triggering

TrustLedger supports integration with external ad networks or analytics engines to:
Receive privacy-preserving watch metrics (e.g., ZK counters, hashed engagement proofs).
Trigger smart contract events tied to ad views, watch time, or platform activity.
Calculate and distribute royalties dynamically based on contribution attribution trees.
Support hybrid models (subscription+ad revenue+on-chain tipping)

These mechanisms allow platforms to reward creators fairly, even when the revenue source is indirect (e.g., from advertisers), while maintaining trustless, programmable enforcement of rights.

### Appendix F—Patentability Justification

### 1. Overview of Patentability Grounds

The invention described in this specification satisfies the requirements for patentable subject matter under Section 18(1) (a) of the Patents Act 1990 and relevant case law (NRDC, Research Affiliates, RPL Central, Encompass, Aristocrat). The invention constitutes a manner of manufacture, as the substance of the invention lies in a technical contribution to the field of digital rights management and AI content provenance.

### 2. Summary of Technical Problem and Technical Solution

| | Technical Problem | Technical Solution |
|---|---|---|
| Module/Feature | Addressed | Provided |
| Proof-of-Origin | Lack of verifiable origin | Cryptographically binds input prompts and |
| Engine | tracking for AI-generated | generation metadata via digital fingerprints and |
| | content | hash chaining mechanisms |
| Prompt Royalty | Difficulty assigning royalties | Encodes dynamic, role-based royalty logic in |
| Engine | in multi-party AI workflows | executable smart contracts and deployable APIs |
| Zero-Knowledge | Exposure of confidential | Implements a privacy-preserving cryptographic |
| License Enforcer | license terms during third- | mechanism (ZK proofs) to confirm license validity |
| | party validation | without disclosing contents |
| Infringement | Absence of automated tools | Uses machine-readable scanning and matching |
| Radar | for detecting derivative AI- | algorithms across public content repositories to |
| | generated works | identify violations |

Each of the above modules contributes to a technical improvement in how digital rights are verified, enforced, and protected in distributed AI content environments. These are not abstract legal frameworks, but specific implementations of novel technical mechanisms.

### 3. Distinction From Non-Patentable Business Methods

This invention does not merely automate a known business practice, nor does it consist of an abstract idea or legal arrangement implemented via conventional computer systems.
The royalty distribution logic is not a financial scheme, but a smart contract-based system executed via blockchain or off-chain modules, reflecting real technical constraints (latency, reversibility, execution dependencies).
The license validation system does not perform basic authentication; it leverages zero-knowledge proofs, a specialized cryptographic approach that solves a genuine technical privacy problem.
The invention's infrastructure includes SDKs, APIS, and smart contracts that are deployable modules, not mere visual interfaces or abstract policies.

The invention results in improvements to the functioning of the computer system and digital content ecosystem itself, as per the criteria in Encompass and Aristocrat.

### 4. Application of IP Australia's Computer-Implemented Invention Criteria

| | Satisfied by | |
|---|---|---|
| Criteria | TrustLedger? | Justification |
| Technical | Yes | Digital provenance, |
| problem solved | | royalty automation, license |
| | | privacy, and enforcement |
| Technical solution | Yes | Custom modules |
| implemented | | (ZK proof engine, smart |
| via computer | | contracts, detection algorithms) |
| Improves | Yes | Enhances traceability, |
| functioning of the | | automation, privacy, and |
| system or data handling | | scalability |
| Does not merely | Yes | Introduces new logic and |
| automate a | | cryptographic primitives |
| known method | | to solve previously |
| | | unaddressed challenges |
| Not merely | Yes | All core modules are |
| a business | | grounded in technical design |
| innovation | | and cryptographic enforcement, |
| | | not abstract rules |

### 5. Conclusion

The TrustLedger system, as claimed, represents a technically implemented infrastructure that solves concrete, computer-related problems associated with AI content attribution, license management, and automated royalty routing. The invention is not directed to a scheme, abstract idea, or business method, but instead provides novel technical solutions with real-world deployment implications.

Accordingly, the invention should be found to meet the “manner of manufacture” requirement under the Patents Act 1990 and is eligible for patent protection in Australia.

This invention does not rely on the mere use of standard computer technology to implement a business scheme. Rather, it provides a specific technical solution to digital provenance, rights enforcement, and zero-knowledge license validation—problems that cannot be adequately solved by conventional computing means alone. The claimed system improves the way computers handle, verify, and enforce intellectual property rights, and is therefore a patentable computer-implemented invention under law.

While fallback implementations such as off-chain architecture (claim 13) and non-ZK validation (claim 10) are included, the preferred embodiments and novel technical contribution reside in the zero-knowledge, cryptographically enforced modular system architecture.

### Appendix G—Market Validation Evidence

Global lawsuits over AI reuse (e.g., GitHub Copilot litigation, OpenAI author complaints)
Demand from creative tools (e.g., Adobe, Canva, Meta's AI Studio)
High-growth AI-generated content sectors lacking attribution tools
Investor interest in Web3 licensing and decentralized creator platforms

### Appendix H—Threat Matrix

| Threat | Mitigation Strategy |
|---|---|
| Competitor | Filed in priority |
| patents | jurisdictions (AU, |
| | US, DE) early |
| Generative model | Prompt fingerprinting & output |
| substitution | hashing prevents bypass |
| Non-compliance by | Silent licensing paths + |
| open-source users | Mirror Vault evidence |
| Legal defense cost | Patent-backed ZK logs + opt-in |
| (litigation) | audit trail to prove ownership |
| Revenue leakage via | Infringement Radar + automated |
| copied outputs | royalty retro-pay triggers |

### Appendix I—Modularity & Licensing Notes

Modules may be licensed separately or bundled:
SaaS API for platforms (e.g., LMS, code hosting, art sites)
Smart contract deployments (on-chain DAOs, NFT licenses)
SDK for enterprise integrations

### Supports:

Usage-based pricing (per API call or asset traced)
Tiered license plans (basic, commercial, resale, etc.)
Revenue-share models for marketplace partners

### Appendix J—Regulatory & Compliance Alignment

GDPR & CCPA: No personal data required for verification
DMCA Compatibility: Mirror Vault acts as takedown archive.
Fair Use Support: Allows traceable secondary use under license.
Global Jurisdictions: ZK proof system is country-neutral; can be audited locally

### Appendix K—Monetization Notes

SaaS model: API key-based pricing for ZK license enforcement, attribution, or royalty routing
Marketplace integration: NFT minting, music streaming, and media licensing platforms
Enterprise model: Licensing to corporations, governments, and regulators (audit/compliance usage)
Legal arm: Option to license MirrorVault-recorded IP to litigation funds or firms pursuing infringement cases

### Appendix L—Platform Leverage & Collaboration Potential

The TrustLedger system is architected not only for creator enforcement and compliance, but for modular integration into existing global platforms, including YouTube, X (Twitter), Meta (Facebook/Instagram), Reddit, Spotify, GitHub, and LLM providers such as OpenAI or Anthropic.

This appendix outlines the functional and commercial pathways by which TrustLedger may be embedded, licensed, or adopted by such platforms to address IP risks, regulatory requirements, and monetization opportunities.

### L.1 Strategic Platform Integration Points

| | Integration | TrustLedger |
|---|---|---|
| Platform | Opportunity | Module |
| YouTube | Auto-detect | Infringement |
| | unlicensed | Radar, ZK License |
| | music/video | Enforcer |
| Instagram/ | Enable content | Proof-of-Origin, |
| Facebook | reuse with licensing | Silent Licensing |
| X (Twitter) | AI content | Prompt Royalty |
| | traceability + prompt | Engine, Proof-of- |
| | attribution | Origin |
| Spotify | Pre-stream | ZK License Enforcer, |
| | license verification | Royalty Routing |
| Platform | Integration Opportunity | TrustLedger Module |
| Reddit | Track reposted AI | Infringement Radar, |
| | summaries and memes | Mirror Vault |
| OpenAI/Claude | License prompt | Prompt Royalty Engine, |
| | chains or outputs | Consent Ledger |
| GitHub | Code snippet | Proof-of-Origin, |
| Copilot | attribution + royalty | Prompt |
| | tracking | Royalty Engine |

### L.2 TrustLedger as a Platform-Independent Rights Layer

TrustLedger is designed as a non-invasive, neutral protocol layer. It may be integrated as:
A backend license validation SDK
A middleware API for proof-of-origin capture.
A frontend creator consent and audit widget.
A policy compliance service for platforms seeking GDPR/AI Act alignment

This ensures that platforms retain UX control while benefiting from TrustLedger's enforcement, licensing, and attribution stack.

### L.3 Collaboration & Licensing Strategy

TrustLedger may be licensed to platforms via one or more of the following models:
White-label SDK License-for internal use with attribution opt-out
Revenue-Sharing API License-tied to creator earnings or enforcement triggers
Compliance-as-a-Service-fixed fee for ZK verification infrastructure
Regulatory Pilot Integration-early-stage adoption in partnership with governments or agencies (e.g., EU Digital Services Act pilot compliance)

### L.4 Technical Differentiation

Due to the patent-backed architecture and ZK-powered privacy compliance, platforms cannot easily rebuild or replicate TrustLedger's system without triggering infringement or omitting critical enforcement logic. This IP defensibility makes collaboration technically more efficient than internal builds.

### Appendix M—Non-Prompt Creator Protection System

TrustLedger is further extended to cover original works that are not generated via prompt-based systems but may later be reused, interpolated, or imitated by AI models. This includes human-created music, art, voice recordings, videos, or writings that become part of training data or stylistic inference.

### M.1 Content-Derived Origin Capture (CDOC)

This module enables manual or automated registration of original works not derived from prompts. It captures and stores unique, tamper-evident fingerprints of uploaded or recorded content, including:
Audio waveform hashes
Visual feature maps.
Style vectors and semantic tone profiles.
Voice or instrumentation signatures.
Timestamped ownership metadata

Each registered item is assigned a Content Origin Certificate that can be referenced in licensing and enforcement events.

### M.2 AI Reuse & Style Interpolation Detection

TrustLedger compares outputs from AI systems against its content vault using perceptual similarity detection, harmonic/melodic comparison, and style embedding overlap.

If reuse or mimicry exceeds a predefined similarity threshold, the system:
Logs the event in Mirror Vault
Verifies whether usage was licensed.
Triggers Silent Licensing, Royalty Enforcement, or optional Takedown Escalation

### M.3 Non-Prompt Royalty Routing

For cases where AI-generated content is derived from style, voice, or motifs of non-prompt works, TrustLedger routes royalty shares to the original creator, such as:
Songwriters or composers whose music was imitated
Visual artists whose brushstrokes or motifs were learned.
Voice actors whose tone was cloned

Smart contracts dynamically allocate royalties to these originators when relevant outputs are monetized or distributed on supported platforms.

### M.4 Expanded Licensing Enforcement Scenarios

This module supports the following additional use cases:
AI voice cloning platforms using celebrity or singer voices
Generative music tools trained on copyrighted catalogs.
Art generation tools emulating specific visual artists.
Video generation trained on old films or independent works.
LLMs summarizing or paraphrasing essays, blog posts, or books

These scenarios now trigger enforcement and licensing checks even without prompt-based inputs, allowing broader protection of creators in the training-data pipeline.

### M.5 Benefits

| Stakeholder | Benefit |
|---|---|
| Human | Can claim royalties from AI |
| creators | reuse of style or voice |
| Platforms | Avoid copyright risk via |
| | proactive license checks |
| Regulators | Gain traceability and consent |
| | verification for training data |
| Model | Can license or exclude registered |
| developers | works from training corpora |

By expanding TrustLedger beyond prompt-driven attribution to include content-derived reuse detection and style-based licensing, the system becomes a comprehensive IP enforcement layer for all creators, regardless of how their work enters the AI ecosystem.

TrustLedger operates within legal boundaries. All enforcement and scanning activities apply only to publicly accessible data or content covered by license, consent, or fair use provisions. The system does not violate platform terms of service and is deployable only where legally permitted.

### Appendix N—Creator Opt-Out and Training Exclusion ENFORCEMENT

### N.1 Creator Opt-Out Registration (No-Train Flag)

TrustLedger enables creators to register their works via the CDOC module with a “Do Not Train” designation. Upon upload, the content origin certificate includes:
A trainable: false flag
A derivative-use: prohibited clause
Encrypted metadata proving the timestamp, fingerprint, and opt-out intent of the creator

This declaration is cryptographically verifiable, even without revealing the full work or the creator's identity.

### N.2 Dataset Monitoring and Unauthorized Inclusion Detection

TrustLedger continuously monitors publicly available and third-party training datasets (e.g., LAION,

Common Crawl, HuggingFace) by:
Scanning for CDOC fingerprints or stylometric matches
Detecting unauthorized inclusion of opted-out content.
Logging violations in Mirror Vault with timestamp, source dataset, and confidence level

This mechanism allows enforcement even if training occurred before opt-out detection.

### N.3 Real-Time SDK/API-Based Exclusion

AI developers and platforms integrating the TrustLedger SDK can:
Perform real-time checks on training inputs or dataset composition.
Receive a TRAINABLE=FALSE response from the CDOC registry
Automatically exclude protected content from ingestion, fine-tuning, or embedding

This enables scalable compliance with opt-out declarations across any AI workflow.

### N.4 License Escalation and Enforcement Protocol

If the system detects unauthorized training or derivative AI outputs based on non-trainable content:
A silent license offer is issued to the violating party with time-limited terms.
If declined or ignored, the system escalates to formal enforcement, including:
Evidence generation via Mirror Vault.
Notification to platform, model custodian, or registry.
Optional legal packaging or arbitration referral

### N.5 Zero-Knowledge Opt-Out Verification

For privacy-preserving protection, TrustLedger supports zk-proof assertions of non-consent, enabling AI platforms to:
Verify that a work was opted-out
Confirm no active license exists.
Avoid unauthorized training or generation—all without learning the artist's identity or underlying terms.

### N.6 Summary Flow: Non-Trainable Content Enforcement

| Step | Action | Module |
|---|---|---|
| 1 | Creator registers work | CDOC |
| | with trainable: false | |
| 2 | Dataset or input is scanned for matches | Infringement Radar |
| 3 | Unauthorized use detected | Mirror Vault |
| 4 | No license confirmed via zk-proof | ZK License Enforcer |
| 5 | Enforcement or license | Escalation Engine |
| | escalation triggered | |

### N.7 Creator Rights Declaration

TrustLedger affirms that creators have the right to refuse AI training, simulation, or mimicry. Whether your work is scraped, stylized, or reproduced by a model, your opt-out is enforceable-cryptographically, programmatically, and legally.

### Appendix O—LLM Memory Traceability Layer

### O.1 Purpose

TrustLedger incorporates a memory traceability protocol to detect when large language models (LLMs) reproduce, leak, or closely paraphrase proprietary or copyrighted content from their training datasets.

### O.2 Functionality

Embeds hashed semantic fingerprints of registered texts into the CDOC system.
Monitors generated outputs for memorization or high-similarity reproduction.
Flags unauthorized reuse and triggers license audits or retroactive royalty offers.

### O.3 Enforcement Workflow

1. Fingerprint of content stored at registration
2. LLM output scanned for signature match
3. Similarity above threshold triggers:
   License check via ZK Enforcer.
   Notification and Mirror Vault log
   Optional silent license offer or enforcement escalation

### O.4 Use Cases

Protects long-form writers, educators, publishers, and public domain stewards from unlicensed LLM-generated summaries, paraphrases, or verbatim reproductions.

### Appendix P—Prompt Chain Attribution Ledger

### P.1 Purpose

Tracks multi-step AI prompting or chained agent interactions to ensure equitable attribution and royalty distribution.

### P.2 Features.

Records prompt IDs and their sequence in composite chains
Weights royalty contributions per prompt layer
Assigns partial credit to upstream agents or humans based on role

### P.3 Integration

Compatible with multi-agent frameworks, toolchains (LangChain, AutoGPT), and composable LLM orchestration environments.

### P.4 Outcome

Enables fractional licensing and multi-party royalty routing across collaborative AI workflows.

### Appendix Q—Derivative Model Tracking Module

### Q.1 Purpose

Extends enforcement to fine-tuned or derivative AI models built on licensed or protected base models.

### Q.2 Core Capabilities.

Logs model fingerprints, fine-tuning events, and hyperparameter deltas.
Links derivative models to their foundational lineages.
Applies royalty or license checks retroactively to base model owners

### Q.3 Platform Impact

Protects open-source model developers, dataset creators, and foundation model providers from unauthorized downstream use.

### Appendix R—AI Model Blacklist & Whitelist Registry

### R.1 Purpose

Enables creators to explicitly allow or deny the use of their content by specific AI models or platforms.

### R.2 Registry Capabilities

Cryptographic blacklists and whitelists with public model IDs.
Accessed by SDK before training or generation.
Supports decentralized opt-out enforcement

### R.3 Use Case

Allows creators to block use by NSFW, disinformation, or ethically incompatible models; and to permit only approved platforms.

### Appendix S—Posthumous Creative Rights Protocol

### S.1 Purpose

Allows creative works and licensing rights to be preserved, inherited, or transferred upon a creator's death.

### S.2 Protocol Features

Smart contract-based beneficiary mapping
Heir-controlled rights management interfaces.
Time-locked licensing triggers and royalty routing

### S.3 Enforcement Tools

Works with CDOC, zk-consent proofs, and license escalator to block unauthorized posthumous AI uses.

### S.4 Example Use Cases

Protection of deceased artists, musicians, writers from unauthorized AI simulation, stylization, or exploitation.

### Appendix T—Consent Ledger For Minors

### T.1 Purpose

Implements age-aware and parental-verified consent tracking for child-generated content.

### T.2 Consent Structure

Requires biometric or tokenized parental signature for upload.
Stores immutable zk-proof of minor status and scope of permission
Flags reuse or training attempts on non-consensual child-originated data

### T.3 Outcome

Provides compliance with child protection laws and ethical AI training safeguards.

### Appendix U—Creative Commons-Style License Profiles

### U.1 Purpose

Provides human-readable, machine-enforceable licensing presets for creators registering assets on TrustLedger.

### U.2 License Templates

Attribution Only.
Non-commercial
Remix OK/Remix Forbidden
Resale Allowed/Blocked

### U.3 Application

SDK returns license profile in query, ZK Enforcer validates, and royalty logic auto-adjusts to license tier.

### U.4 Impact

Democratizes licensing access for creators without legal teams or advanced IP knowledge.

### Appendix V—Interoperability Map

### V.1 Purpose

TrustLedger is designed to interoperate across diverse AI ecosystems and platforms, ensuring portability, compliance, and frictionless adoption regardless of the underlying generation or hosting environment.

### V.2 Supported Integration Targets

OpenAI: Capture prompt-completion pairs via plugin or system log; verify output reuse
Google Gemini/Vertex AI: License validation for enterprise-level outputs and API use
HuggingFace: Fingerprint tracking of datasets and fine-tuned model lineage
Stability AI/Midjourney: Output signature embedding, CDOC match checks, opt-out enforcement
Adobe Firefly: Built-in prompt attribution and permission-aware reuse for branded content
Runway/ElevenLabs/Synthesia: Enforce licensing for voice, video, and avatar content via CDOC+Mirror Vault

### V.3 Developer SDK Modes

JS/TS SDK for browser+frontend tools.
Python SDK for server-side and ML integrations
Solidity SDK for on-chain licensing enforcement
REST API gateway for low-code/no-code access

### V.4 Compatibility Scope

Modules are interoperable with both open-source and proprietary AI stacks, ensuring vendor-neutrality across closed (OpenAI, Adobe) and open (Stable Diffusion, Mistral) models.

### Appendix W—Future Expansion Notes

### W.1 Purpose

This appendix outlines future modules and enforcement logic TrustLedger may develop or license, expanding IP coverage across emerging risks and applications.

### W.2 Upcoming Modules

AI Watermark Stripping Detector
Bias Fingerprint Audit Layer
Multi-Model Conflict Arbitration Engine.
Emotionally Aware Reuse Filters.
Temporal Attribution Decay System

### W.3 Optional IP Pathways

Modules may be developed as:
Utility patents
Licensing extensions
Open modules governed by DAO proposals

### Appendix X—Governance & DAO Readiness

### X.1 Purpose

TrustLedger supports decentralized governance, rights management, and stakeholder control.

### X.2 DAO Architecture

Token-gated voting rights.
On-chain proposal system
Zero-knowledge arbitration and override courts

### X.3 Revenue Participation

Royalty pool distribution.
Smart contract licensing escrow.
Fraud detection and policy review incentives
   X.4 zk-Governance Layer

Zero-knowledge identity allows private, verifiable participation in governance.

### X.5 Strategic Goal

Position TrustLedger as the governance-ready IP rights backbone for decentralized AI.

### Appendix Y—Final Layer Upgrades

### Y.1 Temporal License Expiry Logic

Licenses expire/renew based on date, usage, or trigger count.

### Y.2 Market-Level Royalty Benchmarking

API-driven royalty routing tied to performance signals (e.g., streams, resale).

### Y.3 Emotional & Ethical Reuse Tagging

Detect trauma-linked, grief-based, or sensitive reuse with emotional AI tagging.

### Y.4 ZK Audit Chain for Regulators

Private zk-proof-based audit trail for institutional or government oversight.

### Appendix Z—Rights Dispute & Reversal Protocol

### Z.1 Purpose

Defines process to reverse fraudulent claims, resolve IP disputes, and correct registry errors.

### Z.2 Rights Challenge Mechanism

Parties may challenge registrations using timestamped proof and optional zk-identity.

### Z.3 Dispute Resolution Paths

DAO arbitration
Expert panels
Court-ready audit trails from Mirror Vault

### Z.4 Enforcement Outcomes

Revocation, reassignment, and royalty rerouting
License freeze and Mirror Vault update

### Z.5 Safeguards

Stake/bond required to prevent spam; malicious challengers penalized.

### Appendix AA—Bypass Prevention & Compliance Triggers

### AA.1 Purpose

Defines functional triggers and fallback logic to prevent circumvention.

### AA.2 Trigger Events

System activates when:
AI generates content
Prompts or user input are processed.
Upstream reuse or training occurs

### AA.3 Fallback Mechanisms

If ZK module fails→audit log.

If royalty engine fails→fixed split.

If detection fails→activate hash vault checks.

### AA.4 Escalation

If evasion detected→silent license or legal/DAO escalation begins.

### Appendix AB—Consent Ledger For Dataset Contributors

### AB.1 Purpose

Tracks consent of data contributors used in training datasets.

### AB.2 Fields

Contributor name or pseudonym
Consent status (trainable, commercial, revocable).
Jurisdiction and royalty participation flag

### AB.3 Enforcement

CDOC and MirrorVault validate dataset usage
Consent flags determine royalty eligibility or training exclusion

### Appendix AC—AI Memory Purge & Traceback Protocol

### AC.1 Purpose

Allows creators to trace and remove their content from trained models.

### AC.2 Functionality

CDOC detects reuse.
Prompts traced to model checkpoints.
ZK purge request triggered

### AC.3 Outcome

Model host confirms removal or faces evidence escalation via MirrorVault and legal triggers.

### Appendix AD—AI Licensing Court & Precedent Engine

### AD.1 Purpose

Defines legal resolution system inside TrustLedger.

### AD.2 Court Design

DAO courts +expert panels
On-chain vote enforcement

### AD.3 Precedent Engine

Stores anonymized disputes, rulings, and logic for future reuse.

### AD.4 Smart Enforcement

Outcomes executed via contract:
Royalty reassignment
Freeze
License downgrade
Content delisting

### AD.5 Interoperability

Decisions exportable to external court systems (DMCA, WIPO, EU regulators).

### Appendix AE—Real-World Court Integration Map

### AE.1 Purpose

Outlines how TrustLedger artifacts (e.g., MirrorVault logs, ZK license proofs, consent records) can be used in legal proceedings.

### AE.2 Accepted Legal Artifacts

Timestamped Proof-of-Origin logs.
CDOC fingerprints and content lineage
MirrorVault evidence chain
ZK proofs of license, consent, or ownership

### AE.3 Court-Compatible Formats

PDF notarized logs
JSON+schema export for e-discovery.
Open data standards for admissibility (e.g., ISO/IEC 19794)

### AE.4 Jurisdictions Supported.

U.S. (DMCA, Copyright Act)
EU (AI Act, Copyright Directive).
WIPO Arbitration.
China & India IP Tribunals
UK, Canada, Australia

### AE.5 Strategy

TrustLedger provides mechanisms for creators to initiate enforcement digital IP violations from smart contract enforcement to national or international court systems via exportable, verifiable artifacts.

TrustLedger operates within legal boundaries. All enforcement and scanning activities apply only to publicly accessible data or content covered by license, consent, or fair use provisions. The system does not violate platform terms of service and is deployable only where legally permitted.

Note: These jurisdictions are listed to demonstrate export compatibility of TrustLedger artifacts and do not indicate current enforcement agreements or legal standing in all regions.

### Appendix AF—Anti-Watermark Tampering Defense

### AF.1 Purpose

Protects against attempts to remove or alter AI content watermarks and output fingerprints.

### AF.2 Techniques Detected

Visual watermark removal via inpainting.
Audio filtering of signal fingerprints
Prompt scrambling to bypass origin tracing

### AF.3 Defense Logic

TrustLedger embeds dual-layer fingerprinting (semantic+cryptographic).
Any mismatch or tampering attempt is flagged in Mirror Vault.
Watermark-presence expectation can be enforced via license terms

### Appendix AG—AI Remix Disclosure Flag

### AG.1 Purpose

Promotes transparency in content reuse by enabling optional public disclosure that AI content is derived from human-authored work.

### AG.2 Format

“AI Remix Disclosure” watermark
Optional: name of originating creator or CDOC hash
Displayed in metadata or media overlay

### AG.3 Rights Integration

Activated by original creator consent
Can be mandatory for commercial use of certain licensed works

### Appendix AH—Creator Earnings Dashboard SDK

### AH.1 Purpose

Enables creators to monitor TrustLedger activity around their assets: royalties, usage, and licenses.

### AH.2 Functions

Real-time royalty stream tracker
Mirror Vault reuse log viewer.
License issuance history
Flag and dispute trigger panel

### AH.3 Integration Options

Web widget
Mobile app dashboard.
White-labeled for agencies or labels

### Appendix AI—AI-to-AI Chain Attribution

### AI.1 Purpose

To track content attribution when AI agents use other AI agents or services (multi-hop generation chains).

### AI.2 Function.

Logs each invocation step: originating prompt, intermediate models, final outputs.
Assigns contribution weights to each AI model/operator.
ZK-backed chain of custody establishes who influenced what and when.

### AI.3 Use Cases.

Agent chains in autonomous research
Prompt→image→voice→video pipelines
Liability tracking for AI-generated misinformation or bias

### AI.4 Enforcement

Prompt Royalty Engine and ZK License Enforcer operate across the full invocation chain, compensating all contributors proportionally.

### Appendix AJ—Synthetic Actor/Performer Registry

### AJ.1 Purpose

To protect real or deceased individuals whose likeness or performance style is replicated by AI systems.

### AJ.2 Structure

CDOC fingerprinting for face, voice, movement, and behavioral style.
Estate registration and rights configuration.
License restriction flags: e.g. “no horror roles,” “no deepfake remix,” “explicit consent only”

### AJ.3 Enforcement Integration

Infringement Radar scans avatars, animations, and voices. Violations are logged and routed to estate or rights holder via the Creator Dashboard (Appendix AH).

### Appendix AK—Monetized Derivative Asset Tracker

### AK.1 Purpose

Tracks and enforces royalties for derivative uses of AI-generated content, including ads, merchandise, NFTs, sequels, and adaptations.

### AK.2 Derivative Detection

Hash and fingerprint similarity.
Metadata cross-matching.
Perceptual and semantic drift correlation

### AK.3 Royalty Chain Extension

Allows Prompt Royalty Engine to extend license tracking into secondary and tertiary products, triggering new micro-royalty events.

### Appendix AL—Trustledger Alliance Framework

### AL.1 Purpose

Defines an open governance and legal framework for platforms, studios, and developers adopting TrustLedger.

### AL.2 Key Components

Standard SDK license (MIT/Enterprise dual licensing).
ZK License Proof verification contract.
API usage caps and rate-limited mirror log querying
Royalty pool participation logic

### AL.3 Member Requirements

Participants must implement at least one TrustLedger module and register origin/logs to qualify for interoperability status.

### Appendix AM—Public Verification Badge

### AM.1 Purpose

Enables creators and publishers to display content legitimacy to the public using a TrustLedger badge.

### AM.2 Badge Types.

Verified Origin
Licensed Use.
Royalty Flow Active.
ZK Audit Trail Available

### AM.3 Display Options

Embedded metadata
On-chain token.
Browser widget or social platform plugin

### Appendix AN—Behavioral Signature Tracking

### AN.1 Purpose

Tracks non-visual mimicry of humans such as humor style, storytelling cadence, or performance rhythm.

### AN.2 Detection Logic

Temporal pattern mapping
Tonal and cadence vectoring
ZK-protected anonymized fingerprints

### AN.3 Use Case

Protection for comedians, actors, writers, or speakers whose creative voice is mimicked even if their appearance or name is not used.

### Appendix AO—Interoperable License Token Standard

### AO.1 Purpose

Defines a machine-readable license format compatible with TrustLedger enforcement logic and external platforms.

### AO.2 Token Format.

ERC-721 or ERC-1155 compatible
Fields include: creator ID, prompt hash, model ID, license terms, expiry, usage scope, and royalty logic hash

### AO.3 Integration Targets

IPFS
Arweave.
NFT platforms.
Licensing marketplaces.
Metadata registries (e.g. COALA IP, OpenSea)

Disclaimer: All third-party trademarks referenced herein (e.g., OpenAI, GitHub, Spotify, YouTube, Adobe, Meta, etc.) are the property of their respective owners. Their mention does not imply affiliation, endorsement, or integration unless explicitly licensed.

1. A modular system for managing intellectual property (IP) rights, attribution, licensing, and enforcement of AI-generated digital assets, the system comprising:
a Proof-of-Origin module configured to capture input prompts, model identifiers, generation parameters, and output content from an AI system, compute cryptographic hashes of prompt-output pairs, and store these with timestamps on a verifiable ledger;
a Prompt Royalty Engine configured to calculate and route royalties among stakeholders including prompt authors, model providers, dataset contributors, and content licensors, based on usage context, stakeholder role, and distribution channel;
a Zero-Knowledge License Enforcer configured to verify the existence and validity of an active license for an AI-generated asset using a zero-knowledge proof protocol, such that license terms and identities of licensors and licensees remain undisclosed; and
an Infringement Radar configured to scan publicly available platforms and AI outputs using perceptual hashing and semantic fingerprinting to detect potential violations, and store incident metadata in a tamper-evident MirrorVault for logging and enforcement, wherein each module is deployable via API, SDK, or smart contract infrastructure, and the system supports centralized, decentralized, or hybrid configurations with inter-module coordination logic.

2. The system of claim 1, wherein the Proof-of-Origin module integrates with AI generation platforms and captures model ID, temperature, seed, and session metadata in addition to the input prompt and output, and stores the combined record in an immutable format on a decentralized ledger.

3. The system of claim 1, wherein the Prompt Royalty Engine executes programmable smart contracts that route micro-payments to registered stakeholders upon usage events including but not limited to: streaming, distribution, token minting, commercial resale, or remix generation.

4. The system of claim 1, wherein the Zero-Knowledge License Enforcer utilizes a zk-SNARK or zk-STARK protocol to return a binary indication of license validity while withholding all license content, stakeholder identities, and pricing terms.

5. The system of claim 1, wherein the Infringement Radar compares AI-generated assets against previously registered works using perceptual hashing, stylometric analysis, or deep embedding similarity scoring, and upon match, stores event hashes, URLs, and match confidence scores in MirrorVault.

6. The system of claim 1, further comprising a Content-Derived Origin Capture (CDOC) module configured to register manually created content not derived from prompts by:
(a) computing audio, visual, or stylistic fingerprints from uploaded files;
(b) generating a content origin certificate containing timestamped cryptographic identifiers;
(c) detecting similarity with AI-generated outputs using perceptual or semantic comparison; and
(d) triggering royalty allocation or licensing enforcement actions when commercial reuse is confirmed.

7. The system of claim 6, wherein the CDOC module is applied to protect creators in multiple content domains, comprising:
(a) Al-generated voice synthesis using stored voiceprint identifiers;
(b) generative music using melodic and rhythmic fingerprint comparison;
(c) generative visual art using brushstroke patterns or motif-based style analysis;
(d) cinematic remix generation using scene composition or tonal similarity analysis; and
(e) literary content generation using semantic matching against registered copyrighted text.

8. The system of claim 1, wherein the Proof-of-Origin module and Prompt Royalty Engine are applied to prompt-based generation workflows in one or more verticals, including:
(a) generative image creation platforms,
(b) AI-based music composition tools,
(c) source code generation assistants,
(d) automated journalism and summarization tools,
(e) avatar generation engines,
(f) AI educational tutors, and (g) AI systems for civic or governmental communication.

9. The system of claim 1, wherein the input prompt is generated by an autonomous AI agent, and the system dynamically attributes authorship, license metadata, and royalty allocations based on:
(a) the configuration state of the agent,
(b) the originating environment or upstream model parameters, and
(c) ownership rights associated with human or organizational contributors involved in system initialization or training.

10. A system as described in claim 1, wherein license validation is performed using a signed license token and timestamped audit log stored in a public registry, without employing zero-knowledge proof logic.

11. A system as described in claim 1, wherein the Prompt Royalty Engine uses pre-assigned contributor weightings stored in a fixed-tier database to allocate payouts without requiring runtime dynamic attribution.

12. A system as described in claim 1, wherein the Infringement Radar compares AI outputs solely against a precompiled vault of content hashes without computing perceptual or semantic similarity.

13. A system as described in claim 1, wherein all modules operate in an off-chain architecture using authenticated API keys and hash-based message signing, without requiring blockchain consensus mechanisms.

14. A system comprising one or more computing devices configured with non-transitory memory storing machine-executable instructions which, when executed, perform the operations of: recording AI input/output metadata, attributing ownership via Proof-of-Origin, validating licenses via zk-proofs, routing royalties, and logging infringements into MirrorVault.

15. A software development kit (SDK) configured to expose TrustLedger system functions for third-party integration, including: capture of prompt metadata and manual uploads, license state queries, royalty routing APIs, and enforcement triggers for violation handling.

16. The system of claim 1, wherein datasets used for Al model training are associated with registered content fingerprints, and detection of such content within training inputs triggers one or more of:
(a) automatic attribution to the original content owner,
(b) license validation, or
(c) calculation and routing of dataset-use royalties.

17. The system of claim 1, wherein content generated by an Al system using multi-party prompt chains results in fractional royalty allocation to upstream contributors, the allocation determined by:
(a) contextual role weighting, or
(b) the structural depth of each contributor's prompt within the chain.

18. The system of claim 1, further comprising a license escalation protocol that, upon detection of unauthorized use:
(a) generates a silent license offer, and
(b) escalates enforcement to legal action or arbitration if the offer is not accepted within a predefined time window.

19. The system of claim 1, further comprising a posthumous licensing module configured to:
(a) transfer royalty rights and license control to a digital heir,
(b) execute smart-contract-based beneficiary assignments, or
(c) initiate fallback ownership logic upon detection of creator death or incapacitation.

20. The system of claim 1, further comprising a biometric consent engine configured to verify human consent before reuse of biometric traits, the engine comprising:
(a) biometric signature capture (e.g., voice, image, behavior),
(b) generation of a biometric hash, and
(c) zero-knowledge proof verification of consent state prior to model training or generation.
